(19) United States
(12) Patent Application Publication
(10) Pub. No.: US 2006/0264190 A1
(43) Pub. Date: Nov. 23, 2006

(54) System and method for linearizing nonlinear power amplifiers

(76) Inventor: Boris Aleiner, Somerset, NJ (US)

Correspondence Address: Boris Aleiner, 575 Easton Ave. #20E, Somerset, NJ, 08873, US

(21) Appl. No.: 11/136,015

(22) Filed: May 23, 2005

(51) Int. Cl. H04Q 7/32

(52) U.S. Cl. 455/127.1

(57) ABSTRACT

An apparatus linearizing and technique for linearizing a nonlinear power amplifier used in transmitters of systems for digital wireless communications. Linearization of the nonlinear amplifier is achieved by adding additional signals generated from a specification-given input data stream to the output of the nonlinear power amplifier. The invention allows use of nonlinear power amplifier, which typically enjoys a lower current consumption than that of a linear power amplifier, thus increasing the time between batteries recharges (for user transmitter equipment) and/or reducing the overall size, electric bill expenses, and cooling requirements (for network transmitter equipment). Input data, generated by a given digital wireless standard, is raised to a mathematical power by a required number and converted to RF of a transmitted signal frequency. Then all obtained RF waveforms are added with the same amplitude and the opposite phase to the spectrum of sidelobes generated by nonlinearity of a power amplifier.

### CROSS-REFERENCE TO RELATED APPLICATIONS

Not applicable.

### FEDERALLY SPONSORED RESEARCH OR DEVELOPMENT

Not applicable.

### REFERENCE TO A SEQUENCE LISTING

Not applicable.

### FIELD OF THE INVENTION

The present invention relates generally to digital wireless communications. More particularly, it relates to a linearization technique allowing use of a nonlinear power amplifier in transmitters intended for use in any type of digital wireless communications.

### BACKGROUND OF THE INVENTION

Mobile communications have become a commonplace in today's society. Wireless transmitters are used in cellular phones, satellite phones, satellite radios, data communications (wireless internet), etc.

Generally, the power amplifier provides the energy required to transmit a wireless signal from user equipment to base stations (or vise versa). In every case it is a major contributor to the DC power consumed by the wireless component. Increased efficiency of power amplifiers leads to prolonged battery life of hand-held equipment and reduce a need for expensive cooling of base-station equipment. However increased efficiency leads to worsening linearity, which, in digital communications is realized in the spectrum re-growth (that is, in worsening of Adjacent/Alternative Power Ratio values). To produce efficient power amplifier with acceptable Adjacent Power Ratio (ACPR) values, the linearization methods are used. The goal of linearization is to get rid of spectrum re-growth produced by efficient (that is, nonlinear) amplifier. There are two prevailing schemes for linearization. One of them is called “Predistortion” and characterized by controlling distortions of the input signal. The second is called “Feed-Forward” and characterized by applying corrections to the output signal. As shown in the literature, e.g. B. Aleiner “The Concept of Predistortion”, Microwave Journal, June 2003, “Predistortion” type of linearization has its limitations. It makes Feed-Forward linearization to be the most attractive scheme.

FIG. 1 is a block diagram of conventional Feed-Forward Linearization scheme.

As shown in the Figure, a digitally modulated RF signal is input to the Main Amplifier, 504, operating in efficient (nonlinear) mode. Its output is sampled by the coupler, 506, and subtracted from the input signal by another coupler, 508, to obtain an error signal (spectrum re-growth generated by the Main Amplifier). That error signal is amplified by the Error Amplifier, 512, and through another coupler, 514, is applied to output, where it cancels the error (spectrum re-growth) produced by the Main Amplifier. Vector-Modulators (502 & 510) are used to adjust amplitudes/phases of signals for required cancellation.

While advantages can be gained by applying a Feed-Forward Linearization scheme, there are limitations. For instance, extractions of the analog distortions at the output of coupler, 508, is a cumbersome (thus, inherently inaccurate) procedure; inaccuracy of extraction reduces the degree of linearization, thus suffering a degradation of efficiency of a power amplifier. Future more, conventional Feed-Forward Linearization scheme is costly since it employs expensive components.

Clearly it is beneficial to improve accuracy and reduce cost of conventional analog Feed-Forward linearization schemes.

One technique for improving the accuracy of linearization is by introducing digital controls to analog Feed-Forward linearization schemes. Unfortunately, conventional implementation of digital controls in Feed-Forward linearization schemes utilizes real time adaptation techniques which, while improving an accuracy compare to analog Feed-Forward linearization, do not allow achieving a maximum level of accuracy, thus limiting an achievable level of efficiency.

Thus, there is a need for a simple and inexpensive technique and apparatus for improving the accuracy of feed-forward linearization of power amplifier and maximizing its efficiency by doing so.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of conventional Feed-Forward Linearization scheme;

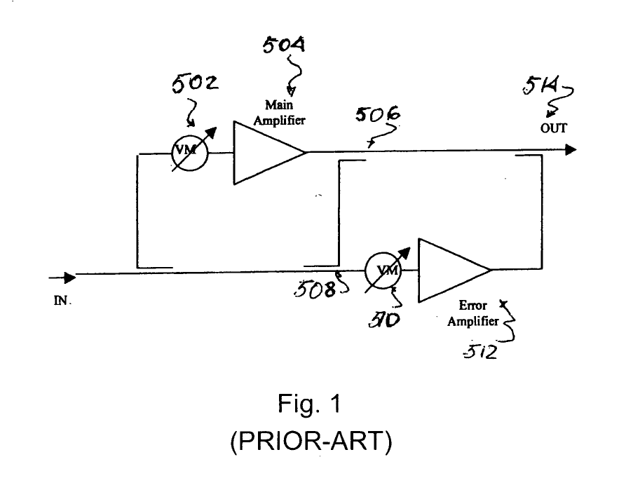

FIG. 2 shows exemplary spectrum plots of a Data Stream as well as its third and fifth order;

FIG. 3 illustrates an exemplary block diagram of a power amplifier linearizing system, in accordance with an embodiment of the present invention;

FIG. 4 is a more detailed exemplary block diagram of the creation of initial data stream raised to the power of 3 waveforms used to obtain simulated results, in accordance with an embodiment of the present invention;

FIG. 5 illustrates exemplary experimental results, which confirm the theoretical predictions of improved performance of the present embodiment;

FIG. 6 illustrates exemplary theoretical results based on software calculations for the corresponding experimental set up of FIG. 5.

Unless otherwise indicated illustrations in the figures are not necessarily drawn to scale.

### SUMMARY OF THE INVENTION

In accordance with the principles of the present invention, a transmitter of a wireless device comprises a power amplifier, a Software (DSP) tool for generation of precise Error Correction Functions, and means to apply generated Error Correction Functions to the output of the power amplifier.

A method of improving efficiency of a power amplifier in a transmitter in accordance with another aspect of the present invention comprises of Software (DSP) Error Correction Functions used to perform a mathematical function of raising the value of an initial data stream to Odd Powers (3, 5, etc). The number of those Functions depends on the required level of accuracy of error cancellation and corresponds to the required highest Power the initial data stream has to be raised to.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

The present invention is directed to a method and apparatus for linearizing a power amplifier intended for use in any type of digital wireless communications.

A problem created by the distorted output signal is in spreading of its spectrum. The closest frequencies to the ones occupied by the main channel (called adjacent and alternative channels) are especially vulnerable to it, since the result of that unwanted spectrum spread could not be filtered out for them. From the fundamental theory it follows that the spectrum spread is happening due to nonlinear effects in power amplifier realized by creation of additional signals at the same frequency as main signal, only with different spectrum representations. When those waveforms added together, they create a resulting waveform with the spectrum representation wider than of the main signal. That portion of the spectrum creating addition to the initial spectrum of a main signal (called “sidelobes”) is landing at the frequencies of adjacent and alternative channels, which impairs the communication at those channels, prohibiting a reliable recognition of data in them.

Mathematically the creation of sidelobes is realized by applying the following equation, known to those skilled in the art to be an equation, describing any type of linearity in any nonlinear system: eout=klein+k3ein3+k5ein5+ . . . where ein—is an input signal, eout—is an output signal, and ki—are complex coefficients.

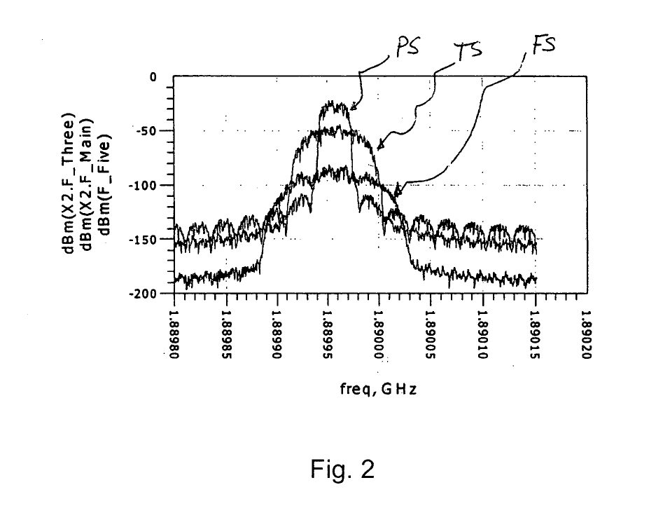

FIG. 2 shows exemplary spectrum plots of a Data Stream as well as its third and fifth order.

As shown in the Figure, a Data Stream utilizes a narrow spectrum DS, while its third order utilizes somewhat wider spectrum TS.

Expanding upon this aspect, the fifth order of a Data Steam spectrum FS utilizes a very wide spectrum.

The combination of all orders of an original Data Stream, created in accordance with the above mentioned mathematical equation, creates sidelobes.

The principles of the present invention make note of the method of sidelobes creation as described on FIG. 2.

The implementation of the invention includes generation of specific orders of an original Data Stream, and addition of the generated orders at the same amplitude and opposite phase in the otherwise conventional manner to the output of the nonlinear power amplifier.

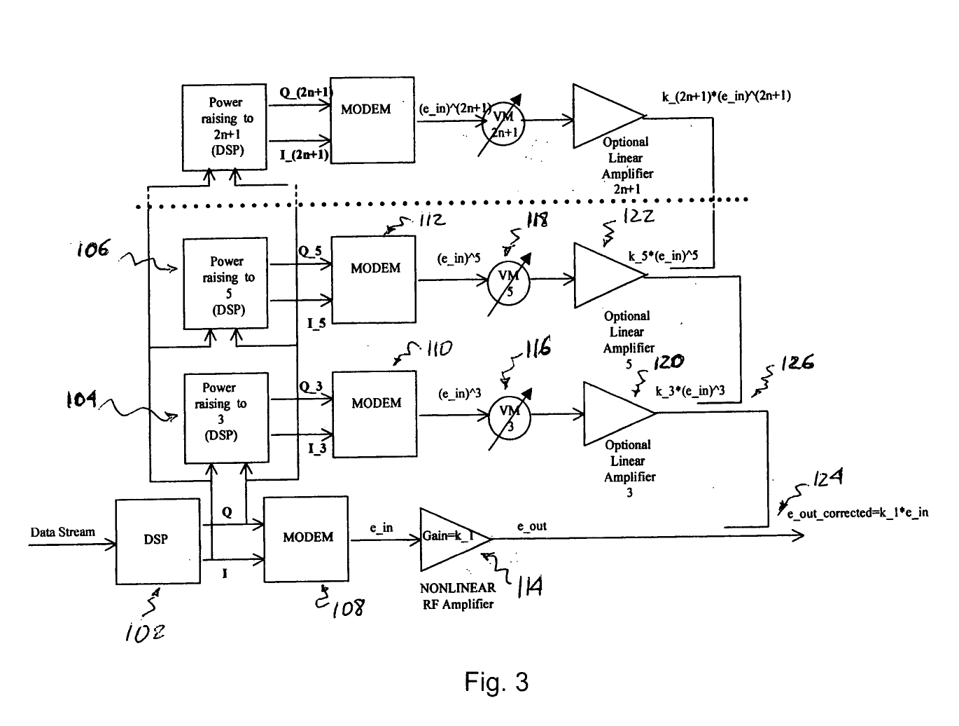

FIG. 3 illustrates an exemplary block diagram of a power amplifier linearizing system, in accordance with an embodiment of the present invention.

As shown in the Figure, in FIG. 3, the Data Stream in form of I&Q digital streams generated in DSP, 102, is applied to its original modem, 108, which is producing a RF input signal to the nonlinear power amplifier, 114. This power amplifier is generating sidelobes as noted on FIG. 2.

In accordance with the principles of the present invention, the Data Stream generated in DSP, 102, is also applied to other portion of DSP input where the mathematical function of power raising to 3, 104, (and, if required—to 5, 106, and etc.) is applied to it. The resulting outputs of original Data Stream are applied to their modems (110, 112, etc)—to create corresponding RF waveforms.

Those RF waveforms produce a significantly improved, if not perfect, compensation of sidelobes, created by the nonlinearity of the power amplifier, 114, when applied to its output in accordance with the teachings of the present invention.

In particular, RF waveforms from the outputs of modems (110, 112, etc) are to be of the same amplitude and the opposite phase to the sidelobes created by the nonlinearity of the power amplifier, 114. Expanding upon this aspect, Vector-Modulators (116 & 118, etc.) and, if necessary, optional linear amplifiers (120, 122, etc) are used to adjust amplitudes/phases of waveforms for required cancellation.

Of note in FIG. 3, in the majority of practical realizations no additional linear amplifiers (120, 122, etc) are to be needed. However, in the relatively unusual case of an amplifier with high-gain and a high-level-of-nonlinearity the optional amplifier devices 120, 122, etc., may be utilized to achieve the required level of cancellation, depending on the needs of the particular application.

Directional couplers or power combiners (124, 126, etc) are used to apply created RF waveforms to the output of the power amplifier, 114.

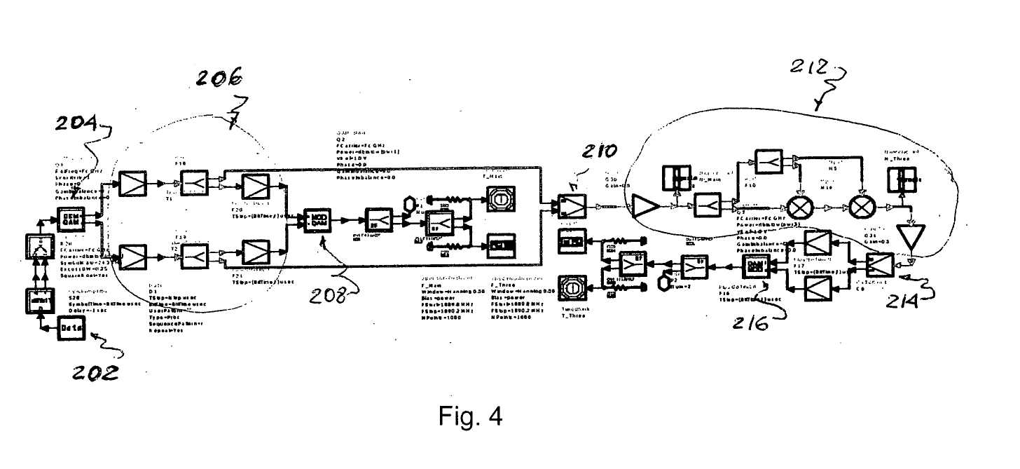

FIG. 4 is a more detailed exemplary block diagram of the creation of initial data stream raised to the power of 3 waveform is used to obtain simulated results, in accordance with an embodiment of the present invention.

As shown in the Figure, a time domain representation of a Data Stream, 202, is split into I&Q on the splitter 204, converted into DSP on 206, and recombined into RF by the modem 208.

At the same time I&Q is recombined into a DSP complex signal on DSP combiner, 210, raised into power of 3 on 212, split into its own I&Q on the splitter 214, and recombined into RF by the modem 216.

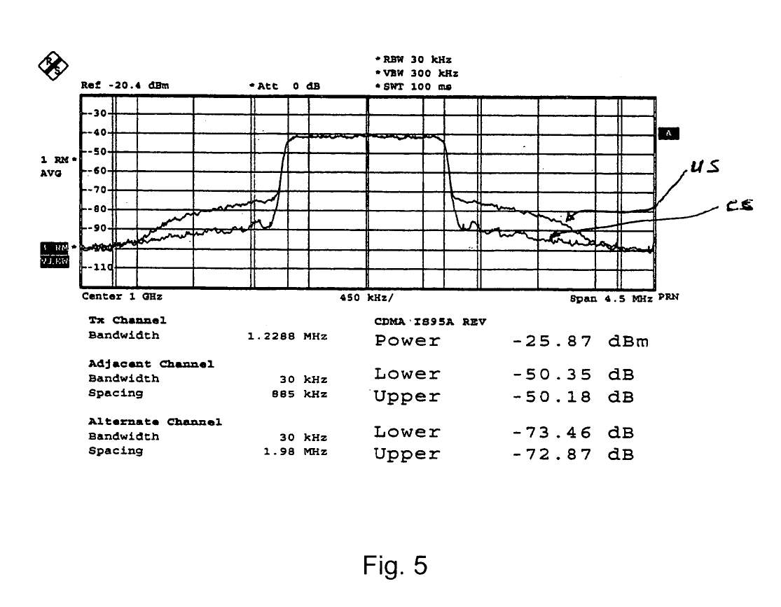

FIG. 5 illustrates exemplary experimental results, which confirm the theoretical predictions of improved performance of the present embodiment.

In particular, as shown in FIG. 5, an uncorrected spectrum of a Data Stream from the nonlinear amplifier output, US, produces ACPR of 50 dBc, while the same said output spectrum but corrected by applying the method prescribed by invention, CS, produces ACPR of 62 dBc.

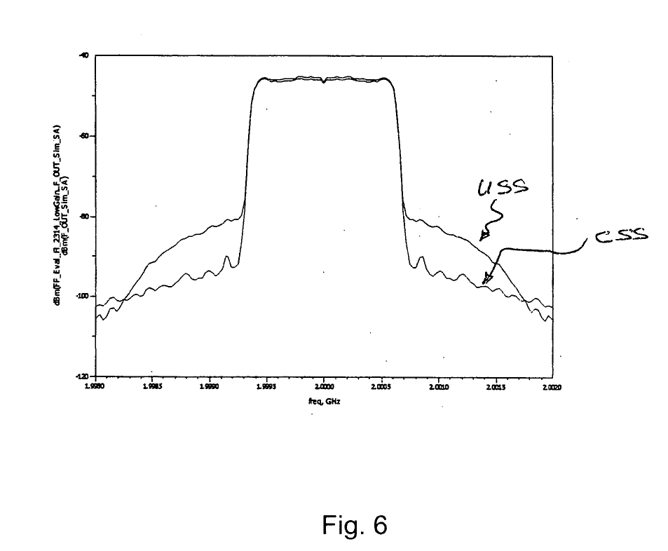

FIG. 6 illustrates exemplary theoretical results based on software calculations for the corresponding experimental set up of FIG. 5.

In particular, figure FIG. 6 depicts an uncorrected spectrum of a Data Stream from the nonlinear amplifier output, USS, and the same said output spectrum but corrected by applying the method prescribed by invention, CSS. Expanding future on those results it confirms the experimental data of FIG. 5.

Having fully described at least one embodiment of the present invention, other equivalent or alternative methods for linearizing nonlinear power amplifiers according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A transmitter of a wireless device, comprising:
a power amplifier;
a set of functions capable of producing special operations on incoming data stream signal, said set of functions including mathematical function of raising the initial value of a signal to an Odd Power:
a set of modems converting said results to RF waveforms; and
a set of devices to add said RF waveforms to the output of said power amplifier.

2. The transmitter of a wireless device according to claim 1, wherein said power amplifier is any type of a nonlinear amplifier.

3. The transmitter of a wireless device according to claim 1, wherein said device is operating in any type of digital wireless environment.

4. The transmitter of a wireless device according to claim 1, wherein said wireless modulated signal is operated upon by said set of mathematical functions before entering said power amplifier.

5. A method of improving efficiency of a power amplifier in a transmitter, comprising the Steps of raising the initial value of an incoming data stream to an odd mathematical power.

6. The method of claim 5, further comprising the Step of reducing spectrum re-growth in digital wireless systems by using set of mathematical functions.

7. The method of claim 5, wherein said power amplifier is a nonlinear amplifier.

8. An apparatus for improving efficiency of a power amplifier in a transmitter, the apparatus comprising:
means for creating a set of functions capable of raising the initial value of an incoming data stream to odd mathematical powers; and
means for canceling error in an incoming data stream.

9. The apparatus of claim 8, further comprising means for reducing spectrum re-growth in digital wireless systems.

10. The apparatus of claim 8, wherein said power amplifier is a nonlinear amplifier.
